(19) United States
(12) Patent Application Publication
(10) Pub. No.: US 2026/0115104 A1
(43) Pub. Date: Apr. 30, 2026

(54) Dual-Chamber Feeding Bottle Device

(71) Applicant: Stephanie McQueen-Arthur, Tampa, FL (US)

(72) Inventor: Stephanie McQueen-Arthur, Tampa, FL (US)

(21) Appl. No.: 19/317,216

(22) Filed: Sep. 3, 2025

Related U.S. Application Data
(60) Provisional application No. 63/711,208, filed on Oct. 24, 2024.

(51) Int. Cl. A61J 9/00

(52) U.S. Cl. CPC A61J 9/003

(57) ABSTRACT

A dual-chamber feeding bottle device is provided. The device is designed to minimize milk waste and prevent contamination through a compartmentalized structure. The device comprises a lower reservoir chamber for storing milk in a sterile environment and an upper feeding chamber that dispenses controlled portions of milk. A button mechanism allows the user to transfer milk incrementally, ensuring only the required amount is exposed during feeding while preserving the remainder for future use. The device incorporates durable, hygienic materials, volume markings for precise measurement, and optional features such as a color-changing temperature indicator and a vacuum-sealed construction for thermal retention. The device also features secure connections between components, including reciprocating fasteners and gaskets, ensuring leak-proof functionality and easy cleaning. The dual-chamber design enhances feeding efficiency, reduces waste, and provides a practical solution for infant care by maintaining sterility and enabling portion-controlled milk dispensing.

### CROSS-REFERENCE TO RELATED APPLICATION

The present application claims priority to, and the benefit of, U.S. Provisional Application No. 63/711,208, which was filed on Oct. 24, 2024, and is incorporated herein by reference in its entirety.

### FIELD OF THE INVENTION

The present invention relates generally to the field of feeding bottles. More specifically, the present invention relates to a feeding bottle that prevents contamination via a dual-chamber design comprising a sterile lower reservoir and an upper feeding chamber that dispenses controlled portions. The device also has a button mechanism for incremental milk transfer between the reservoir and the chamber. Accordingly, the present disclosure makes specific reference thereto. Nonetheless, it is to be appreciated that aspects of the present invention are also equally applicable to other like applications, devices, and methods of manufacture.

### BACKGROUND

Traditional baby bottles store a single volume of milk or formula, exposing the entire quantity to potential contamination once a baby begins feeding. Pediatric experts advise that milk exposed to a baby's mouth should be consumed within one to two hours; otherwise, bacteria growth poses health risks. This limitation results in significant milk waste, especially for mothers who rely on breastmilk and may struggle to produce an adequate supply. Baby formula is also costly, and discarding unused portions leads to unnecessary financial burden. Additionally, parents often face difficulties in precisely controlling milk flow, which can cause overfeeding or the need for frequent interruptions during feeding. Maintaining milk at an optimal temperature throughout feeding presents another challenge, particularly during travel or nighttime feedings. Conventional baby bottles do not offer an effective way to store and dispense milk incrementally while ensuring hygiene and minimizing waste. These challenges necessitate an improved feeding solution that allows parents to manage milk distribution efficiently while maintaining its safety and freshness.

Therefore, there exists a long-felt need in the art for a dual-chamber feeding bottle that minimizes milk waste by allowing controlled milk dispensing. There also exists a long-felt need in the art for a dual-chamber feeding bottle that prevents contamination by keeping a portion of the milk sealed and sterile until needed. Moreover, there exists a long-felt need in the art for a dual-chamber feeding bottle that enhances convenience by enabling parents to regulate milk flow and temperature more effectively.

The subject matter disclosed and claimed herein, in one embodiment thereof, comprises a dual-chamber feeding bottle device. The device is designed to minimize milk waste and prevent contamination through a compartmentalized structure. The device comprises a lower reservoir chamber for storing milk in a sterile environment and an upper feeding chamber that dispenses controlled portions of milk. A button mechanism allows the user to transfer milk incrementally, ensuring only the required amount is exposed during feeding while preserving the remainder for future use. The device incorporates durable, hygienic materials, volume markings for precise measurement, and optional features such as a color-changing temperature indicator and a vacuum-sealed construction for thermal retention. The device also features secure connections between components, including reciprocating fasteners and gaskets, ensuring leak-proof functionality and easy cleaning. The dual-chamber design enhances feeding efficiency, reduces waste, and provides a practical solution for infant care by maintaining sterility and enabling portion-controlled milk dispensing.

In this manner, the dual-chamber feeding bottle device of the present invention accomplishes all the foregoing objectives and provides an improved feeding bottle with a compartmentalized design that separates stored milk from the feeding portion. The lower reservoir chamber maintains milk in a sealed, uncontaminated state, while the upper feeding chamber dispenses controlled amounts as needed. The button-operated dispensing mechanism ensures precise milk transfer, reducing unnecessary exposure and minimizing waste. The inclusion of an insulated body helps maintain milk at an optimal temperature, offering additional convenience. Fasteners and leak-proof gaskets further provide a reliable seal, facilitating safe storage and transport. By addressing contamination risks, improving portion control, and reducing waste, the dual-chamber feeding bottle represents a significant advancement over conventional feeding bottles, enhancing both feeding efficiency and cost-effectiveness for caregivers.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a dual-chamber feeding bottle device. The dual-chamber feeding bottle device is designed to minimize milk waste and prevent contamination through a compartmentalized body comprising a lower reservoir chamber and an upper feeding chamber. This configuration enables controlled milk dispensing, ensuring only a portion of the total milk volume is exposed during feeding while maintaining sterility in the remaining milk.

The body is composed of durable, hygienic materials such as BPA-free food-grade silicone or plastic. To enhance thermal retention, the body may feature a double-walled vacuum-sealed or foam-insulated construction. The dual-chamber design facilitates efficient milk management, with the lower reservoir chamber storing a larger milk volume in a sealed environment. The upper feeding chamber, which connects to a nipple, allows for controlled milk dispensing. The chambers are removably attached via reciprocating fasteners for easy cleaning and refilling.

At least one button enables caregivers to dispense milk into the upper feeding chamber in precise increments. The nipple is removably attached to the upper feeding chamber using reciprocating fasteners. These fasteners ensure a secure connection while allowing for easy removal and replacement of the nipple for cleaning or swapping. Flexible food-grade gaskets may be incorporated to create a secure seal between the nipple and the upper feeding chamber, preventing leaks. Additional gaskets may be included between the lower reservoir chamber and the upper feeding chamber to enhance the seal and maintain sterility.

The lower reservoir chamber is airtight, allowing for safe storage in a refrigerator or travel bag. A leak-proof cap, which may be threaded, snap-on, or magnetic, ensures secure scaling for pre-filled storage.

During operation, milk is stored in the lower reservoir chamber under sterile conditions. When feeding is required, the button is pressed to transfer a controlled milk amount into the upper feeding chamber via a valve. The baby then consumes the milk from the nipple, with any remaining milk in the lower reservoir chamber preserved for future use. As a result, the device offers a hygienic, cost-effective solution for infant feeding by reducing waste, preventing contamination, and improving feeding efficiency. By enabling controlled milk dispensing while maintaining sterility in the unused portion, the device presents a significant advancement over traditional baby bottles.

A method of using the device includes providing the dual-chamber feeding bottle, filling the lower reservoir chamber with milk, pressing the button to transfer milk into the upper feeding chamber when feeding is needed, allowing the baby to consume the milk from the nipple, and storing any remaining milk in the lower reservoir chamber.

Accordingly, the dual-chamber feeding bottle device of the present invention is particularly advantageous as it provides an improved feeding bottle with a compartmentalized design that separates stored milk from the feeding portion. The lower reservoir chamber maintains milk in a sealed, uncontaminated state, while the upper feeding chamber dispenses controlled amounts as needed. The button-operated dispensing mechanism ensures precise milk transfer, reducing unnecessary exposure and minimizing waste. The inclusion of an insulated body helps maintain milk at an optimal temperature, offering additional convenience. Fasteners and leak-proof gaskets further provide a reliable seal, facilitating safe storage and transport. By addressing contamination risks, improving portion control, and reducing waste, the dual-chamber feeding bottle represents a significant advancement over conventional feeding bottles, enhancing both feeding efficiency and cost-effectiveness for caregivers. In this manner, the dual-chamber feeding bottle device overcomes the limitations of existing feeding bottles known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a dual-chamber feeding bottle device of the present invention in accordance with the disclosed architecture;

FIG. 2 illustrates an exploded perspective view of one potential embodiment of a dual-chamber feeding bottle device of the present invention in accordance with the disclosed architecture;

FIG. 3 illustrates a perspective view of a lower reservoir chamber of one potential embodiment of a dual-chamber feeding bottle device of the present invention in accordance with the disclosed architecture; and

FIG. 4 illustrates a flowchart of a method of using one potential embodiment of a dual-chamber feeding bottle device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a dual-chamber feeding bottle that minimizes milk waste by allowing controlled milk dispensing. There also exists a long-felt need in the art for a dual-chamber feeding bottle that prevents contamination by keeping a portion of the milk sealed and sterile until needed. Moreover, there exists a long-felt need in the art for a dual-chamber feeding bottle that enhances convenience by enabling parents to regulate milk flow and temperature more effectively.

The present invention, in one exemplary embodiment, is comprised of a dual-chamber feeding bottle device. The dual-chamber feeding bottle device is designed to reduce milk waste and prevent contamination through a compartmentalized body comprising a lower reservoir chamber and an upper feeding chamber. This structure allows controlled milk dispensing, ensuring only a portion of the total milk volume is exposed during feeding while maintaining sterility in the remaining milk.

The body is made of durable, hygienic materials such as BPA-free food-grade silicone or plastic. To enhance thermal retention, the body may incorporate a double-walled vacuum-scaled or foam-insulated construction. The dual-chamber design enables efficient milk management, with the lower reservoir chamber storing a larger milk volume in a sealed environment. The upper feeding chamber, which connects to a nipple, facilitates controlled milk dispensing. The chambers are removably attached using reciprocating fasteners for easy cleaning and refilling.

At least one button allows caregivers to dispense milk into the upper feeding chamber in precise increments. The nipple is removably attached to the upper feeding chamber using reciprocating fasteners, ensuring a secure connection while allowing for easy removal and replacement for cleaning or swapping. Flexible food-grade gaskets may be included to create a secure seal between the nipple and the upper feeding chamber, preventing leaks. Additional gaskets may be positioned between the lower reservoir chamber and the upper feeding chamber to reinforce the seal and maintain sterility. The lower reservoir chamber is further airtight, enabling safe storage in a refrigerator or travel bag. A leak-proof cap, which may be threaded, snap-on, or magnetic, ensures secure sealing for pre-filled storage.

During use, milk is stored in the lower reservoir chamber under sterile conditions. When feeding is needed, the button is pressed to transfer a controlled milk amount into the upper feeding chamber via a valve. The baby then consumes the milk from the nipple, while any remaining milk in the lower reservoir chamber is preserved for future use. This design provides a hygienic, cost-effective solution for infant feeding by reducing waste, preventing contamination, and improving feeding efficiency. By enabling controlled milk dispensing while maintaining sterility in the unused portion, the device represents an improvement over traditional baby bottles.

A method of using the device includes providing the dual-chamber feeding bottle, filling the lower reservoir chamber with milk, pressing the button to transfer milk into the upper feeding chamber when needed, allowing the baby to consume the milk from the nipple, and storing any remaining milk in the lower reservoir chamber.

Therefore, the dual-chamber feeding bottle device offers an improved design that separates stored milk from the feeding portion. The lower reservoir chamber maintains milk in a sealed, uncontaminated state, while the upper feeding chamber dispenses controlled amounts as needed. The button-operated dispensing mechanism ensures precise milk transfer, minimizing unnecessary exposure and waste. The inclusion of an insulated body helps maintain milk at an optimal temperature, providing added convenience. Fasteners and leak-proof gaskets further enhance sealing, ensuring safe storage and transport. By addressing contamination risks, improving portion control, and reducing waste, the dual-chamber feeding bottle provides a significant improvement over conventional feeding bottles, enhancing both feeding efficiency and cost-effectiveness for caregivers. In this way, the dual-chamber feeding bottle device overcomes the limitations of existing designs.

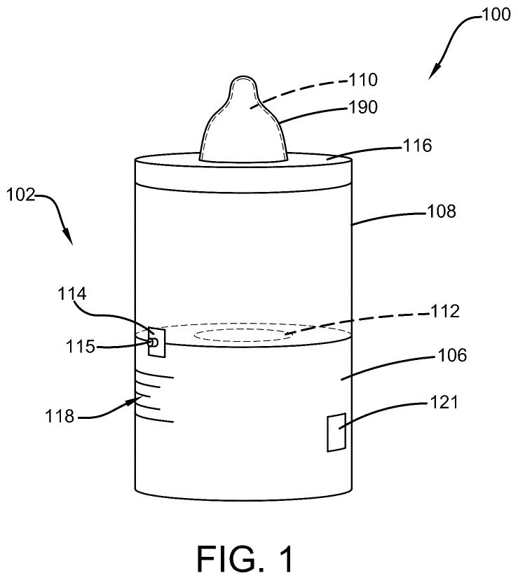

Referring initially to the drawings, FIG. 1 illustrates a perspective view of one potential embodiment of a dual-chamber feeding bottle device 100 of the present invention in accordance with the disclosed architecture. The dual-chamber feeding bottle device 100 is designed to minimize milk waste and prevent contamination by incorporating a compartmentalized body 102. The dual-chamber feeding bottle device 100 is comprised of two separate internal compartments 104, including a lower reservoir chamber 106 and an upper feeding chamber 108. This configuration allows a controlled quantity of milk to be dispensed into the upper feeding chamber 108 to the lower chamber 106 while keeping the remaining milk in the lower reservoir chamber 106 sterile and uncontaminated. The ability to dispense milk incrementally ensures that only a portion of the total milk volume is exposed to a baby's mouth, preserving the freshness of the unused milk for future feedings.

The body 102 is comprised of a durable, hygienic material such as, but not limited to, BPA-free, food-grade silicone or plastic. In one embodiment, the body 102 is comprised of a combination of rigid and flexible materials, with the lower reservoir chamber 106 formed from a rigid material for stability and the upper feeding chamber 108 formed from a softer, squeezable material to facilitate milk flow. To maintain milk temperature for extended periods, the body 102 may include a double-walled vacuum-sealed construction or a double-walled foam construction to reduce heat transfer and enhance thermal retention. In one embodiment, the body 102 is textured with a recessed or recessed texture to improve grip.

The body 102 may be comprised of volume markings 118 in units such as, but not limited to, milliliters or ounces to assist in precise milk measurement and portioning. The volume markings 118 may be embossed, printed, or etched for durability. In one embodiment, the body 102 is comprised of a color-changing temperature indicator 121 such as, but not limited to, thermochromic paint, heat-sensitive strips, or liquid crystal films to signal whether the milk is at an optimal feeding temperature. The temperature indicator 121 may change color based on preset temperature thresholds, providing a visual cue for users.

The dual-chamber configuration of the body 102 allows for efficient milk management. More specifically, lower reservoir chamber 106 is designed to store a larger volume of milk while maintaining a sealed, sterile environment. The upper feeding chamber 108 connects directly to a nipple 110, allowing milk to be dispensed in controlled amounts. The upper feeding chamber 108 and the lower reservoir chamber 106 are in fluid communication and are removably attached via reciprocating fasteners 160, 162, which may include, but are not limited to, threaded connections, bayonet fittings, snap-fit couplings, or magnetic attachments. The reciprocating fasteners 160, 162 provide a secure yet detachable connection, allowing easy separation for cleaning, storage, or refilling.

At least one button 114 (as seen in FIG. 1) allows caregivers to dispense milk into the upper feeding chamber 108 in precise increments based on the baby's feeding needs. The button 114 may be positioned at the side of the body 102 for thumb operation or on the bottom for a squeeze-activated release. In one embodiment, the button 114 may include a locking mechanism 115, such as, but not limited to, a sliding lock, a push-and-twist mechanism, a latch, a recessed button, etc. to prevent accidental dispensing.

The upper feeding chamber 108 connects to the nipple 110, which may be any style such as, but not limited to, a standard, orthodontic, or anti-colic nipple. The nipple 110 may be removably attached to the upper feeding chamber 108 via reciprocating fasteners 170, 172, which may include, but are not limited to, threaded connections, bayonet fittings, snap-fit couplings, or magnetic attachments. The reciprocating fasteners 170, 172 provide a secure connection while allowing for easy removal and replacement of the nipple 110 for cleaning, sterilization, or swapping with a different nipple style. The nipple 110 may be comprised of a removable cap 190 of any style.

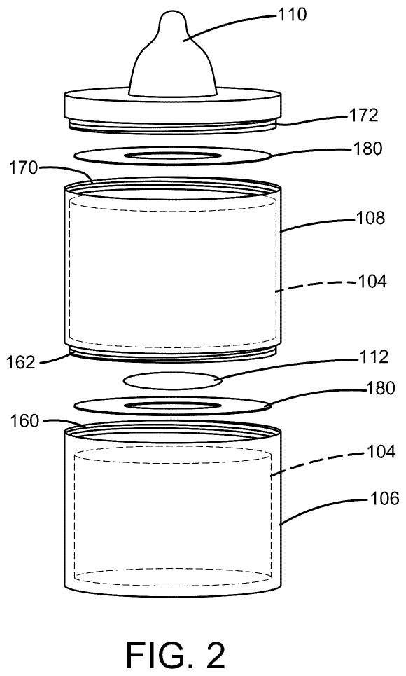

Various gaskets 180 (as seen in FIG. 2) may also be included as needed to create a secure seal between the nipple 110 and the upper feeding chamber 108, preventing leaks and ensuring proper attachment. The gaskets 180 may be comprised of a flexible, food-grade material such as, but not limited to, silicone or rubber to provide durability and maintain hygiene. In one embodiment, the gaskets 180 may be removable for cleaning or replacement. Additionally, the gaskets 180 may be incorporated between the lower reservoir chamber 106 and the upper feeding chamber 108 to enhance the seal created by the reciprocating fasteners 160, 162. This configuration ensures that milk transfer between the chambers 106, 108 occurs without leakage while maintaining a sterile environment in the lower reservoir chamber 106.

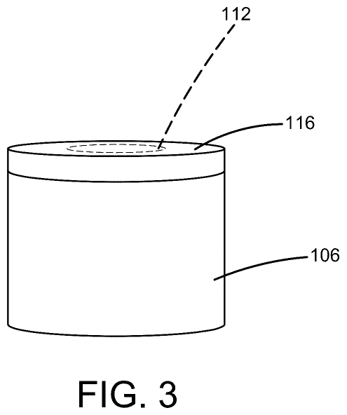

The lower reservoir chamber 106 is further designed to be airtight, allowing it to be safely stored in a refrigerator or a travel bag. A leak-proof cap 116 (as seen in FIG. 3) may be included to enable pre-filling of the lower reservoir chamber 106 without concerns of leakage or contamination. The cap 116 may be threaded, snap-on, or magnetic for secure attachment.

During operation, milk is stored in the lower reservoir chamber 106 under sterile conditions. When feeding is required, the button 114 is pressed to transfer a desired quantity of milk into the upper feeding chamber 108 through a removable one-way valve 112. The baby then feeds from the nipple 110, which is connected to the upper feeding chamber 108. Any milk remaining in the lower reservoir chamber 106 can be stored in a refrigerator by disconnecting the upper feeding chamber 108 from the lower reservoir chamber 106. This design ensures that only a portion of the milk is exposed during feeding, reducing waste and preserving the unused milk for future use.

The dual-chamber feeding bottle device 100 provides a practical, hygienic, and cost-effective solution for infant feeding by preventing milk contamination, reducing waste, and enhancing feeding efficiency. By allowing caregivers to dispense milk in controlled increments while maintaining sterility in the unused portion, the dual-chamber feeding bottle device 100 represents a significant improvement over traditional baby bottles.

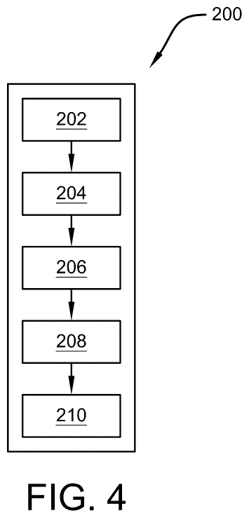

The present invention is also comprised of a method of using 200 the dual-chamber feeding bottle device 100, as seen in FIG. 4. First, the dual-chamber feeding bottle device 100 is provided, comprising a body 102 comprised of a lower reservoir chamber 106, an upper feeding chamber 108, a valve 112, at least one button 114, and a nipple 110 [Step 202]. Then, a desired quantity of milk (or other liquid) is poured into the lower reservoir chamber 106 [Step 204]. Next, when feeding is required, the button 114 is pressed, allowing a controlled amount of milk to transfer from the lower reservoir chamber 106 into the upper feeding chamber 108 via the valve 112 [Step 206]. Then, the baby consumes the milk from the nipple 110, which is connected to the upper feeding chamber 108 [Step 208]. Finally, any remaining milk in the lower reservoir chamber 106 can be stored [Step 210].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “dual-chamber feeding bottle device” and “device” are interchangeable and refer to the dual-chamber feeding bottle device 100 of the present invention.

Notwithstanding the foregoing, the dual-chamber feeding bottle device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the dual-chamber feeding bottle device 100 as shown in the FIGS. are for illustrative purposes only, and that many other sizes and shapes of the dual-chamber feeding bottle device 100 are well within the scope of the present disclosure. Although the dimensions of the dual-chamber feeding bottle device 100 are important design parameters for user convenience, the dual-chamber feeding bottle device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A dual-chamber feeding bottle device comprising:
a body comprising a lower reservoir chamber and an upper feeding chamber in fluid communication with the lower reservoir chamber;
wherein the lower reservoir chamber is comprised of a configured to control the transfer of a liquid from the lower reservoir chamber to the upper feeding chamber;
a button operatively connected to the valve, wherein actuation of the button facilitates the transfer of a controlled quantity of milk from the lower reservoir chamber to the upper feeding chamber through the valve; and
a nipple removably attached to the upper feeding chamber.

2. The dual-chamber feeding bottle device of claim 1, wherein the valve is comprised of a one-way valve.

3. The dual-chamber feeding bottle device of claim 1, wherein the body is comprised of a double-walled vacuum-sealed material or a double-walled foam material.

4. The dual-chamber feeding bottle device of claim 1 further comprised of a locking mechanism.

5. The dual-chamber feeding bottle device of claim 4, wherein the locking mechanism inhibits activation of the button.

6. The dual-chamber feeding bottle device of claim 1, wherein the body is comprised of a volume marking.

7. The dual-chamber feeding bottle device of claim 1, wherein the body is comprised of a temperature indicator.

8. The dual-chamber feeding bottle device of claim 1, wherein the body is textured.

9. The dual-chamber feeding bottle device of claim 7, wherein the temperate indicator.

10. A dual-chamber feeding bottle device comprising:
a body comprising a lower reservoir chamber comprised of a rigid material and an upper feeding chamber comprised of a flexible material in fluid communication with the lower reservoir chamber;
wherein the upper feeding chamber removably attaches to the lower reservoir chamber;
wherein the lower reservoir chamber is comprised of a configured to control the transfer of a liquid from the lower reservoir chamber to the upper feeding chamber;
a button operatively connected to the valve, wherein actuation of the button facilitates the transfer of a controlled quantity of milk from the lower reservoir chamber to the upper feeding chamber through the valve; and
a nipple removably attached to the upper feeding chamber.

11. The dual-chamber feeding bottle device of claim 10 further comprised of a gasket.

12. The dual-chamber feeding bottle device of claim 10, wherein the lower reservoir chamber and the upper feeding chamber attach via a first pair of reciprocating fasteners.

13. The dual-chamber feeding bottle device of claim 10, wherein the upper feeding chamber and the nipple removably attach a second pair of reciprocating fasteners.

14. The dual-chamber feeding bottle device of claim 10, wherein the nipple is comprised of a cap.

15. The dual-chamber feeding bottle device of claim 10, wherein the lower reservoir chamber is comprised of a leak-proof cap.

16. The dual-chamber feeding bottle device of claim 10, wherein the valve is comprised of a one-way valve.

17. The dual-chamber feeding bottle device of claim 10, wherein the body is comprised of a volume marking.

18. The dual-chamber feeding bottle device of claim 10, wherein the body is comprised of a temperature indicator.

19. The dual-chamber feeding bottle device of claim 10 further comprised of a locking mechanism that inhibits an activation of the button.

20. A method of using a dual-chamber feeding bottle device, the method comprising the following steps:
providing a dual-chamber feeding bottle device comprised of a body with a lower reservoir chamber comprised of a valve, an upper feeding chamber removably attached to the lower reservoir chamber, a button, and a nipple;
filling the lower reservoir chamber with a liquid;
actuating the button to transfer a controlled amount of the liquid from the lower reservoir chamber to the upper feeding chamber via the valve;
feeding an infant from the nipple connected to the upper feeding chamber; and
storing any remaining liquid in the lower reservoir chamber for future use.
